(19) United States
(12) Patent Application Publication
(10) Pub. No.: US 2002/0125649 A1
(43) Pub. Date: Sep. 12, 2002

(54) Shaft seal

(76) Inventors: Stephan Bross, Erpolzheim (DE); Gerhard Schwarz, Dackenheim (DE); Bernhard Brecht, Neustadt/Weinstrasse (DE); Ruediger Koepp, Ludwigshafen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/013,957

(22) Filed: Dec. 13, 2001

(30) Foreign Application Priority Data
Dec. 13, 2000 (DE) 100 62 204.6

(51) Int. Cl. F16J 15/16

(52) U.S. Cl. 277/579

(57) ABSTRACT

A seal which is arranged between a shaft and a casing opening and separates, from one another, two spaces at different pressures, with the exception of a residual annular gap which permits a slight leakage caused by a gap flow. The seal can replace prior seal types and only permits a very small leakage volume flow while being relatively uncomplicated in terms of components, assembly and maintenance. The seal includes a bush (13) tightly surrounding the shaft (2), having at least one grooves (14) in each of which is arranged, with slight axial clearance, an elastic annular element (15, 18, 20, 21, 23) split by a longitudinally extending gap (16, 17, 19). The pressure difference between axial end surfaces of the annular element(s) (15, 18, 20, 21, 23) urges the annular element(s) (15, 18, 20, 21, 23) into sealing contact with the casing opening (3) in such a way that the gap flow is guided via the annular gap between the groove(s) (14) and the annular element(s) (15, 18, 20, 21, 23).

### BACKGROUND OF THE INVENTION

The present invention relates to a seal which is arranged between a shaft and a casing opening and separates, from one another, two spaces at different pressures, with the exception of a residual annular gap which permits a slight leakage caused by a gap flow.

Leaking shaft seals, such as floating ring seals or stuffing boxes, have the object of throttling down a certain pressure difference at the lowest possible leakage volume flow. A joint disadvantage of the known shaft seals is the fact that they have a complicated configuration. In the case of stuffing boxes, it is also true that they require a comparatively high operating expenditure because of the necessary inspections and maintenance. Floating ring seals, on the other hand, cause a relatively high leakage loss.

### SUMMARY OF THE INVENTION

The object of the invention is to provide a shaft seal which can take the place of the aforementioned shaft seals.

Another object is to provide a shaft seal which only permits a very small leakage volume flow.

A further object of the invention is to provide a shaft seal which is relatively uncomplicated in terms of components, assembly and maintenance.

These and other objects are achieved in accordance with the present invention by providing a bush tightly surrounding the shaft, having at least one groove in each of which is arranged, with slight axial clearance, an elastic or resilient annular element split by a longitudinally extending gap, in which arrangement the pressure difference present between axial end surfaces of an annular element urges the annular element into sealing contact with the casing opening in such a way that the gap flow is guided via the annular gap present between the groove and the annular element.

During the assembly of the shaft seal, the annular element can, because of the gap which splits it, be widened and pushed over the edge of the bush, subsequently engaging in the groove which accommodates it. Provided that it is open, the gap in the annular element forms a fluid-guiding connection between the end surfaces of the annular element.

The annular gap existing between the annular element and the casing opening is closed by the annular element. A gap flow now only exists through the gap in the annular element itself and through the gap which exists between the annular element and the adjacent walls of the groove accommodating the annular element.

Due to the different pressures which exist in the gaps between the end surfaces of the annular element and the lateral boundary walls of the groove, which is located between the high-pressure side and the low-pressure side, an axial force occurs which acts on the annular element. This axial force displaces the annular element in the direction of the low-pressure side so that the width of the annular gap there is reduced and its throttling effect is increased.

The tribological behavior of the shaft seal depends on the material pairing selected between the annular element and the bush accommodating the latter and on the resultant axial force which presses the end surface of the annular element against the flank of the groove. By suitable selection of the annular geometry, i.e. the ratio of the ring length l to the inner and outer ring diameters dᵢ and dₐ, respectively, it is possible to reduce the resultant axial force Fₐₓ to such an extent that the throttling effect caused by the reduction in the gap is maintained without wear occurring due to mixed friction between the annular end surface and the groove flank surface, i.e. so that a hydrodynamic lubricant film is built up and maintained.

The annular element is self-adjusting due to the force relationships acting on the ring. This is achieved by compensation for a part of the axial force being provided by the static frictional force, which occurs due to the pressing of the ring outer surface onto the casing wall, taking into account the static coefficient of friction μ present.

These conditions are satisfied if the annular element has a geometry which satisfies the relationship:

$$\frac{1}{4} ( \frac{{ⅆ}_{a}^{2}}{{ⅆ}_{i}^{2}} - 1 ) < μ \cdot \frac{l}{{ⅆ}_{i}} < \frac{1}{2} ( \frac{{ⅆ}_{a}^{2}}{{ⅆ}_{i}^{2}} - 1 )$$

The build-up and the maintenance of the hydrodynamic lubricant film are favored by regular or irregular structures introduced into the end surface, such as ridges, grooves or depressions. Longitudinal holes, which connect the axial end surfaces, increase the formation of lubricant film and improve the self-adjusting effect of the annular element.

In accordance with one advantageous embodiment of the invention, the course of the gap located in an annular element has a shape which increases the gap length. In a plan view onto a projection of the surface of the annular element, the course of the gap does not extend in a straight line on the shortest path between the end surfaces but is oblique, undulating, bent, meandering, zigzag-shaped or has any other given shape which departs from a straight line. Such a shape of the gap makes it possible to influence the throttling effect within the gap.

A seal can be introduced into the gap in order further to increase the throttling effect of the gap or to close the gap completely. This can be formed by a sealing strip of flexible, elastic material. According to another embodiment of the invention, however, the gap splitting the ring can be tightly closed, after assembly in the groove of the bush carrying it, by the introduction of a material which is capable of flowing during its processing. On this point, it should be noted that the possibility of spreading the ring due to the pressure present must not be impaired by such a measure. The annular element itself or parts of it can consist of a pressure-resistant elastic material.

The embodiments of the invention are not limited to rectangular annular cross sections. In fact, the mode of operation also applies to angular or trapezoidal ring embodiments.

One advantageous embodiment comprises a series arrangement of a plurality of rings. An integrated arrangement is achieved by the bottom of the groove and the inner contour of the annular element being formed by straight or otherwise shaped, and therefore mutually engaging, recesses.

The shaft seal according to the invention is suitable for use instead of a stuffing box or a floating ring seal and also, therefore, for replacing such seals during a retrofit operation.

### BRIEF DESCRIPTION OF THE DRAWING

The invention will be described in further detail hereinafter with reference to illustrative embodiments shown in the accompanying drawings, in which:

FIG. 1 shows a sectional partial view of a turbomachine with a shaft seal according to the invention, which replaces a stuffing box;

FIG. 2 shows a sectional partial view of another turbomachine with a shaft seal according to the invention, which replaces a floating ring seal;

FIGS. 3 and 4 show two views of a ring element inserted in the shaft seal according to the invention; and

FIGS. 5 to 10 show various alternative ring element embodiments.

### DETAILED DESCRIPTION OF ILLUSTRATIVE EMBODIMENTS

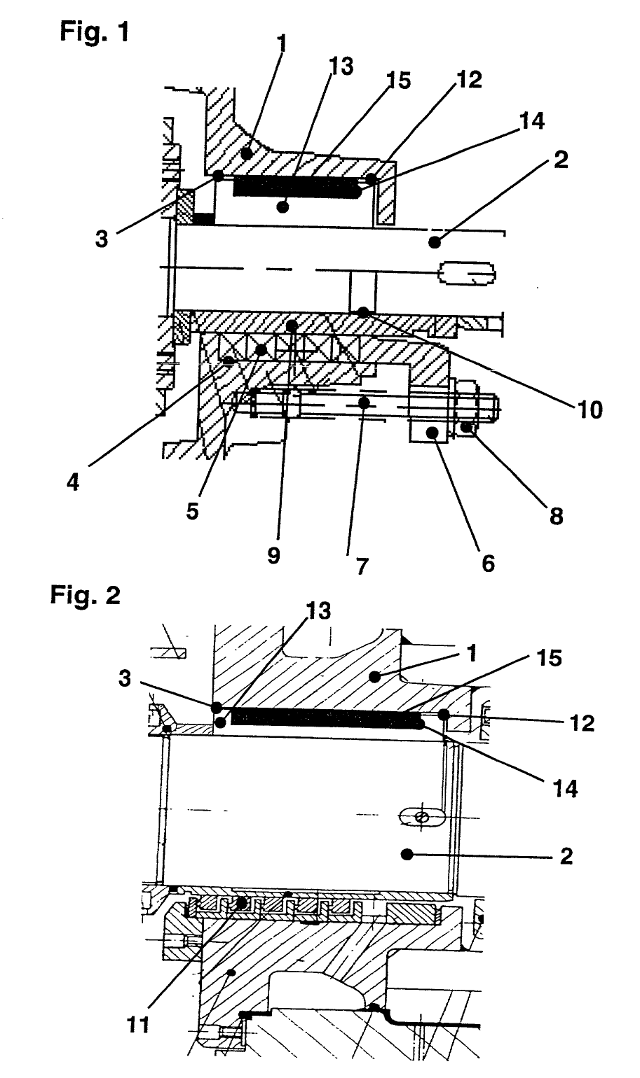

The partial view shown in FIG. 1 depicts parts of a rotary pump casing 1 and a shaft 2 which extends through the rotary pump casing 1. The rotary pump casing 1 has a casing opening 3 in which a shaft seal is located.

In the lower part of FIG. 1, the shaft seal is formed by a stuffing box 4 whose individual packing rings 5 are held with a certain initial pressure by a stuffing box gland 6 and a plurality of bolts 7 and 8 nuts distributed around the periphery. In order to prevent the packing rings 5 from causing wear on the shaft 2, the shaft is enclosed in an exchangeable sleeve 9. In order to prevent a leakage flow between the shaft 2 and the sleeve 9, the gap between these two parts must be closed by a static seal 10.

The pressure exerted on the stuffing box 4 during operation of the rotary pump determines the gap remaining between the stuffing box 4 and the sleeve 9 and, therefore, the degree of sealing. In this arrangement, care must be taken to assure that the adjustment of the pressure, which takes place by means of the nuts 8, on the one hand provides adequate sealing but, on the other hand, does not cause any hindrance to the shaft 2 or increased wear on the stuffing box 4 and the sleeve 9. Because, however, there is necessarily a certain wear even with the best adjustment of the pressure, the shaft seal must be regularly checked and readjusted from time to time. Finally, the packing rings 5 and, if necessary, the sleeve 9 must be renewed after a specified time.

It can be readily seen that the shaft seal with a stuffing box is very complicated with respect to construction and maintenance and that, in the event of lack of inspection and maintenance, a substantial increase in the leakage volume is to be expected.

The floating ring seal 11 illustrated in the lower part of FIG. 2 has substantially lower maintenance requirements. It does, however, permit a relatively high leakage volume and can, in consequence, only be employed within a narrowly limited range of applications. In addition, it is again subject to the disadvantage of complicated construction.

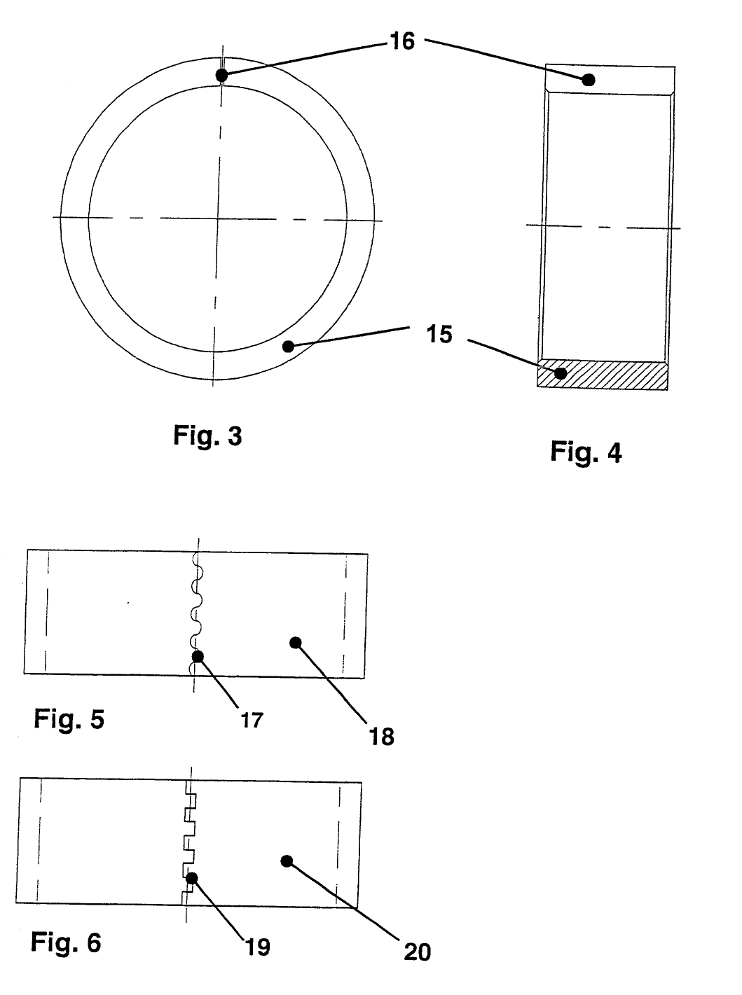

The shaft seal 12 according to the invention, as depicted in the upper parts of FIGS. 1 and 2, has, as can be quickly seen at first glance, a relatively simple construction with only a small number of uncomplicated parts. A bush 13 is pushed onto the shaft 2 and this bush carries an annular element 15 in a groove 14. As can be seen from FIGS. 3 and 4, the annular element 15 has a gap 16 which extends axially. The gap 16 permits deformation in such a way that the annular element 15 can be pushed over the bush 13 and brought into engagement in the groove 14.

The annular element 15 has a small axial clearance relative to the end walls of the groove 14 in which it is received. This affects the achievable leakage volume and the tribological behavior of the shaft seal 12.

During the operation of the rotary pump, the pressure difference present between the inside of the pump and atmosphere, on the one hand, presses the annular element 15 so that it seals against the casing opening 3, and, on the other hand, the pressure building up in the gap between the groove 14 and the internal diameter of the annular element 15 consequently presses the annular element axially in the direction of the atmosphere-side end surface of the groove 14. As a result, the gap located at this point becomes narrower, its throttling effect is increased, and the leakage volume is decreased.

The tribological behavior of the groove 14/annular element 15 pairing depends on the materials selected for this pairing and on the resulting axial force which presses the end surface of the annular element 15 against the flank of the groove 14. The ring geometry (ratio of the ring length l to the internal or external ring diameter, dᵢ and dₐ, respectively), which is designed in accordance with the relation:

$$\frac{1}{4} ( \frac{{ⅆ}_{a}^{2}}{{ⅆ}_{i}^{2}} - 1 ) < μ \cdot \frac{l}{{ⅆ}_{i}} < \frac{1}{2} ( \frac{{ⅆ}_{a}^{2}}{{ⅆ}_{i}^{2}} - 1 )$$

leads to the resultant axial force Fₐₓ being reduced to such an extent that the throttling effect due to the narrowing of the gap is maintained without frictional wear occurring due to mixed friction between the end surface of the annular element 15 and the flank surface of the groove 14, i.e. to a hydrodynamic lubricant film being built up and maintained.

Because of the force relationships acting on the annular element 15, the annular element is self-adjusting. This is achieved by compensation being provided for a part of the axial force by the static friction force, which occurs due to the pressure of the outer surf ace of the annular element 15 on the casing opening 3, taking into account the prevailing static coefficient of friction μ.

A further path for the leakage volume flow is provided by the gap 16 in the annular element 15. The size of the leakage volume flowing at this point is determined by the width and length of the gap 16, i.e. by the throttling effect generated here. The throttling effect can be increased by changing the course, and therefore the length, of the gap 16.

FIGS. 5 and 6 show examples of this. Both the gap 17, which extends in an undulating manner in the annular element 18 of FIG. 5, and the meandering gap 19 in the annular element 20 of FIG. 6 increase the gap length available for the throttling and, therefore, the throttling effect. There is, furthermore, an additional throttling effect due to the deflection of the leakage flow occurring within a gap 17 or 19. Other embodiments in addition to the gap shapes represented are also possible, such as a zigzag gap course or arbitrary combinations of different line guidance arrangements.

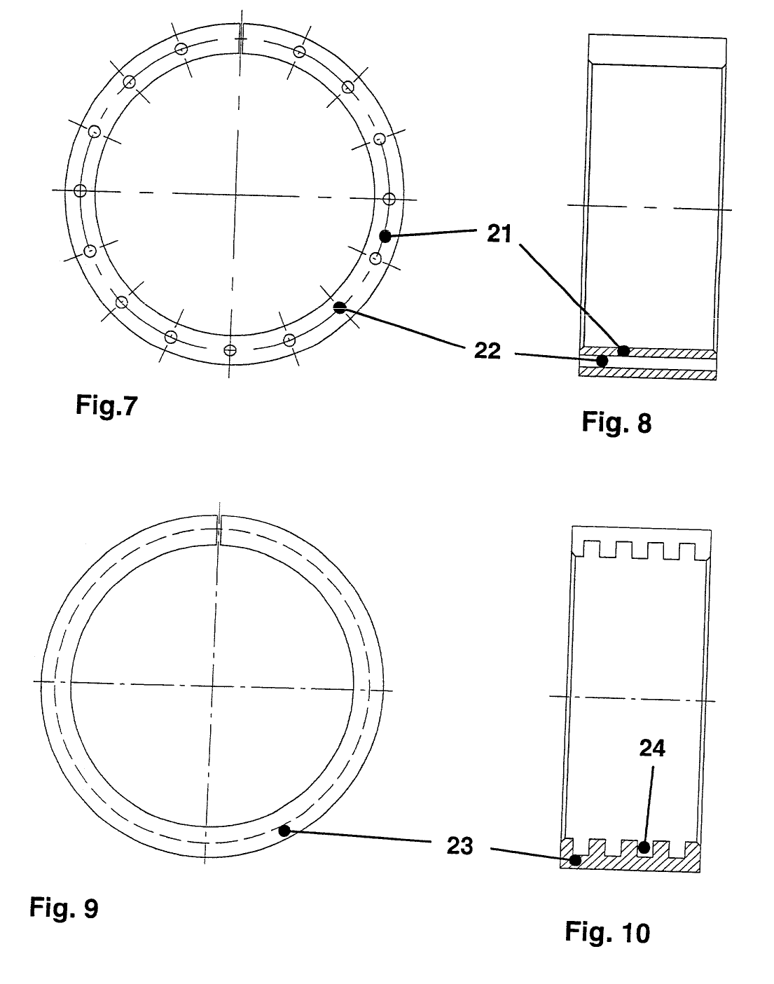

An alternative annular element embodiment 21, which is provided with axially extending holes 22, is depicted in FIGS. 7 and 8. The holes 22 conduct fluid from the side of the annular element 21 with higher pressure to the side with lower pressure. The fluid emerging at the latter end surface acts as a lubricant film between this end surface and the adjacent groove wall.

A further alternative configuration of the annular element is shown in FIGS. 9 and 10. The annular element 23 shown there is provided with recesses 24 which engage with corresponding annular protrusions within the groove of the bush (not shown) in which the annular element 23 is received.

Likewise not shown in the drawing are embodiments such as those in which the gap splitting the annular element is closed by an additional seal introduced into the gap. Such a seal can, for example, be formed by a flexible insert disposed in the gap. Such seals are briefly compressed on introduction of the annular element into the casing or into the bush installed there in order to fill the gap after the subsequent spreading of the annular element. It can, however, also be a seal introduced into the gap after the installation of the annular element, which seal is capable of flowing during the processing and fills the gap in the operating condition of the seal. Depending on its type and application, such a seal is suitable for increasing the throttling effect of the gap or completely preventing a leakage volume flow at this point.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. A seal for installation between a shaft and a casing opening to separate two spaces at different pressures from one another, with the exception of a residual annular gap which permits a slight leakage caused by a gap flow, said seal comprising a bush tightly surrounding the shaft, said bush having at least one groove in each of which an elastic annular element is arranged with slight axial clearance, each said elastic annular element being split by a longitudinally extending gap, wherein a pressure difference between axial end surfaces of each annular element urges the annular element into sealing contact with the casing opening in such a way that the gap flow is guided through an annular gap present between the groove and the annular element.

2. A seal according to claim 1, wherein the gap which splits the annular element forms a liquid-carrying, pressure-transmitting connection between the axial end surfaces of the annular element.

3. A seal according to claim 1, wherein the gap which splits the annular element has a shape which gives the gap a length greater than that of the annular element.

4. A seal according to claim 3, wherein the gap which splits the annular element has an oblique, undulating, bent, meandering or zigzag configuration.

5. A seal according to claim 3, wherein the gap which splits the annular element has a non-linear configuration.

6. A seal according to claim 1, wherein the annular element has geometric dimensions which satisfy the relation:
$$\frac{1}{4} ( \frac{{ⅆ}_{a}^{2}}{{ⅆ}_{i}^{2}} - 1 ) < μ \cdot \frac{l}{{ⅆ}_{i}} < \frac{1}{2} ( \frac{{ⅆ}_{a}^{2}}{{ⅆ}_{i}^{2}} - 1 )$$
where
dₐ is the outer diameter of the annular element,
dᵢ is the inner diameter of the annular element,
μ is the static coefficient of friction between the annular element and the casing, and
l is the length of the annular element.

7. A seal according to claim 1, wherein the pressure difference across the annular element produces a resultant axial force which urges the axial end surface of the annular element on the low pressure side against a flank of the groove in which the annular element is received so that a sealing gap which is formed between said axial end surface and said gap flank on the low-pressure side and through which radial leakage flow occurs, is adjusted to a minimum value.

8. A seal according to claim 1, wherein the annular element is provided with axial holes which connect the axial end surfaces of the annular element.

9. A seal according to claim 1, further comprising a seal member disposed in the gap which splits the annular element.

10. A seal according to claim 9, wherein said seal member comprises a sealing strip of a flexible, elastic material disposed in said gap.

11. A seal according to claim 9, wherein said seal member is comprised of a flowable substance introduced into said gap during manufacture of the seal, said substance subsequently setting to close said gap.

12. A seal according to claim 1, wherein the axial end surfaces of the annular element are provided with profiling or with regular or irregular structures.

13. A seal according to claim 1, wherein the axial end surfaces of the annular element are provided with ridges, grooves or depressions.

14. A seal according to claim 1, wherein the annular element is at least partially formed of a pressure-resistant elastic material.

15. A seal according to claim 1, wherein said annular element has a non-rectangular cross sectional configuration.

16. A seal according to claim 15, wherein said annular element has a trapezoidal cross sectional configuration.

17. A seal according to claim 15, wherein said annular element has a triangular cross sectional configuration.

18. A seal according to claim 1, wherein said bush comprises a plurality of grooves each having a respective annular element received therein.

19. A seal according to claim 1, wherein each groove of the bush has a bottom contour formed with recesses and each annular element has an inner contour with projecitons which engages the recesses in the groove bottom.

20. A method of replacing a stuffing box seal or a floating ring seal on a rotatable shaft extending through an opening in a casing, said method comprising removing the stuffing box seal or floating ring seal and installing in place thereof a seal comprising a bush which tightly surrounds the shaft, said bush having at least one groove in each of which an elastic annular element is arranged with slight axial clearance, each said elastic annular element being split by a longitudinally extending gap, wherein a pressure difference between axial end surfaces of each annular element urges the annular element into sealing contact with the casing opening in such a way that a gap leakage flow is guided through an annular gap present between the groove and the annular element.
